(19) United States
(12) Patent Application Publication
(10) Pub. No.: US 2013/0067970 A1
(43) Pub. Date: Mar. 21, 2013

(54) STEERING LOCK DEVICE

(71) Applicant: Hirofumi GOSHIMA, Aichi (JP)

(72) Inventor: Hirofumi GOSHIMA, Aichi (JP)

(73) Assignee: Kabushiki Kaisha Tokai Rika Denki Seisakusho, Aichi (JP)

(21) Appl. No.: 13/585,133

(22) Filed: Aug. 14, 2012

(30) Foreign Application Priority Data
Sep. 20, 2011 (JP) 2011-204400

(51) Int. Cl. B60R 25/02

(52) U.S. Cl. 70/187

(57) ABSTRACT

A steering lock device includes a rotating member to be rotated by a key, a locking member to move between a unlock position that a steering shaft is allowed to be rotated and a lock position that the steering shaft is prevented from being rotated, a sliding member to move the locking member by converting the rotation of the rotating member into a linear movement, a case member enclosing the rotating member, the locking member and the sliding member, and a cushioning mechanism disposed in an opposite wall formed in the case member, the opposite wall being opposite to a transfer space in which the sliding member is movable. The cushioning mechanism is configured to reduce an impact force generated when the sliding member contacts with the opposite wall.

The present application is based on Japanese patent application No. 2011-204400 filed on Sep. 20, 2011, the entire contents of which are incorporated herein by reference.

### BACKGROUND OF THE INVENTION

1. Field of the Invention

This invention relates to a steering lock device (or steering shaft lock device) and, in particular, to a steering lock device for blocking rotation of a vehicle steering shaft (i.e., a steering wheel connected thereto).

2. Description of the Related Art

A vehicle steering system is provided with a steering lock device to block a turning of a steering shaft so as to prevent a vehicle theft (e.g., JP-A-2008-238950).

In the steering lock device, when a key rotor with a key inserted is turned from “ACC” or “ON” position to “LOCK” position, a locking bar moves toward a steering shaft together with a slider operable to slide in a lock body to engage with the steering shaft to restrict the rotation of the steering shaft. By contrast, when the key rotor is turned in the opposite direction to the above operation direction, the locking bar moves toward an unlock position opposite the steering shaft together with the slider to unlock the steering shaft to allow the rotation of the steering shaft.

### SUMMARY OF THE INVENTION

The steering lock device of JP-A-2008-238950 is constructed such that a stopper part for preventing the disengagement of the locking bar is formed on an opposite wall to the slider of the lock body, whereby upon the locking of the steering shaft, the locking bar is engaged with the steering shaft while having the slider contact the lock body to restrict the rotation of the steering shaft.

Upon the locking of the steering shaft, the slider is subjected to a cyclic load and a shock load caused by the contact between the slider and the lock body. Therefore, with respect to the slider with a shape to increase a bending moment, it is necessary to consider the crack or break of the slider due to metal fatigue.

Accordingly, it is an object of the invention to provide a steering lock device with an enhanced durability and reliability.

### (1) According to One Embodiment of the Invention, a Steering Lock Device Comprises:

a rotating member to be rotated by a key;

a locking member to move between a unlock position that a steering shaft is allowed to be rotated and a lock position that the steering shaft is prevented from being rotated;

a sliding member to move the locking member by converting the rotation of the rotating member into a linear movement;

a case member enclosing the rotating member, the locking member and the sliding member; and

a cushioning mechanism disposed in an opposite wall formed in the case member, the opposite wall being opposite to a transfer space in which the sliding member is movable,

wherein the cushioning mechanism is configured to reduce an impact force generated when the sliding member contacts with the opposite wall.

In the above embodiment (1) of the invention, the following modifications and changes can be made.

(i) The cushioning mechanism comprises a lid portion to contact with the sliding member and a damping member supporting the lid portion,

wherein the lid portion is disposed via the damping member in the opposite wall so as to protrude from the opposite wall.

(ii) The lid portion protrudes from the opposite wall by such a distance that a speed of the sliding member can be attenuated.

(iii) The damping member comprises one of a spring, a rubber, the air and a viscous body.

(iv) One of the sliding member and the lid portion comprises an elastic material on a contact face that the sliding member and the lid portion contact with each other.

(v) The sliding member contacts with the opposite wall such that the locking member can be prevented from falling off the case member.

(vi) The steering lock device further comprising a lock body through which the locking member is movable,

wherein the lock body comprises the opposite wall in which the cushioning mechanism is disposed.

(vii) The cushioning mechanism is installed in a concave portion formed in the opposite wall.

(viii) The cushioning mechanism comprises a lid portion to contact with the sliding member and a damping member supporting the lid portion,

wherein the lid portion is disposed via the damping member in the concave portion so as to protrude from the opposite wall.

(ix) The lid portion is movable parallel to the locking member.

Points of the Invention

According to one embodiment of the invention, a steering lock device is provided with a slider cushioning mechanism that is constructed such that in order to increase the action time upon the collision from the position where a slider contacts with a lid portion of the slider cushioning mechanism until the slider reaches the inner wall of a lock body (as a stopper for the slider), the lid portion is arranged to protrude from the inner wall of the lock body via the compression coil spring by a distance L sufficient to attenuate the impact speed.

### BRIEF DESCRIPTION OF THE DRAWINGS

The preferred embodiments according to the invention will be explained below referring to the drawings, wherein:

FIG. 1A is a schematic side view showing a steering lock device in a preferred embodiment of the invention;

FIG. 1B is a bottom view showing the steering lock device in FIG. 1A;

FIG. 2 is a longitudinal sectional view showing an internal structure of the steering lock device in FIG. 1A;

FIG. 3 is a schematic cross sectional view showing a locking bar and a steering shaft in the steering lock device in FIG. 1A; and

FIGS. 4A and 4B are schematic sectional views showing a cushioning mechanism of the steering lock device in FIG. 1A, where FIG. 4A illustrates an operation before a slider contacts a wall of a lock body, and FIG. 4B illustrates an operation when the slider contacts the wall of the lock body.

### DETAILED DESCRIPTION OF THE PREFERRED EMBODIMENTS

The preferred embodiments according to the invention will be detailed below referring to the drawings.

Overall Structure of Steering Lock Device

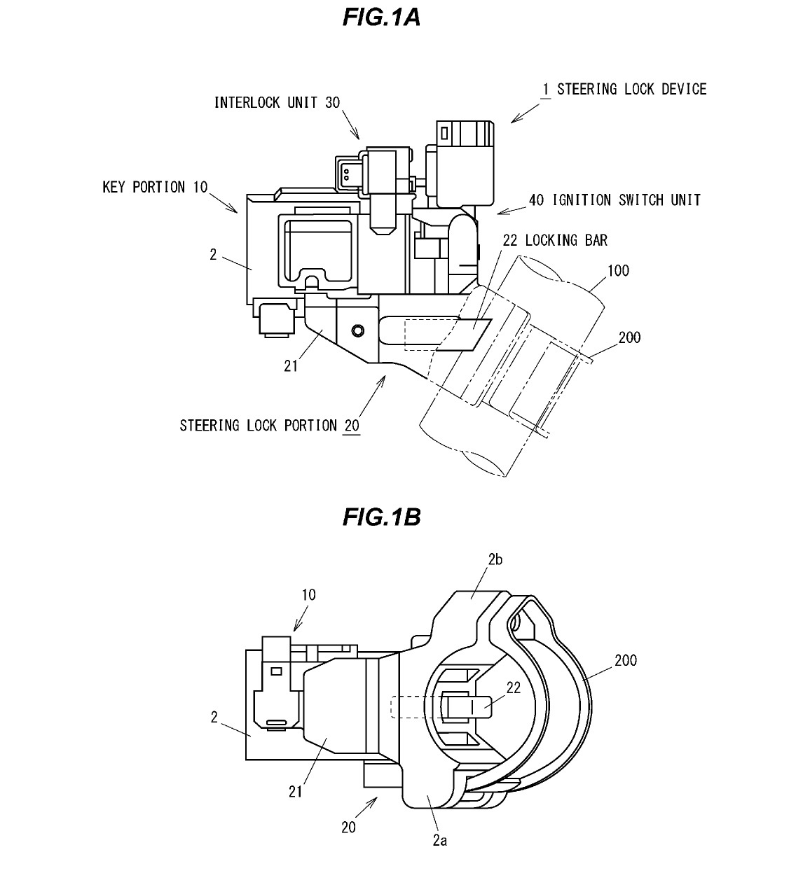

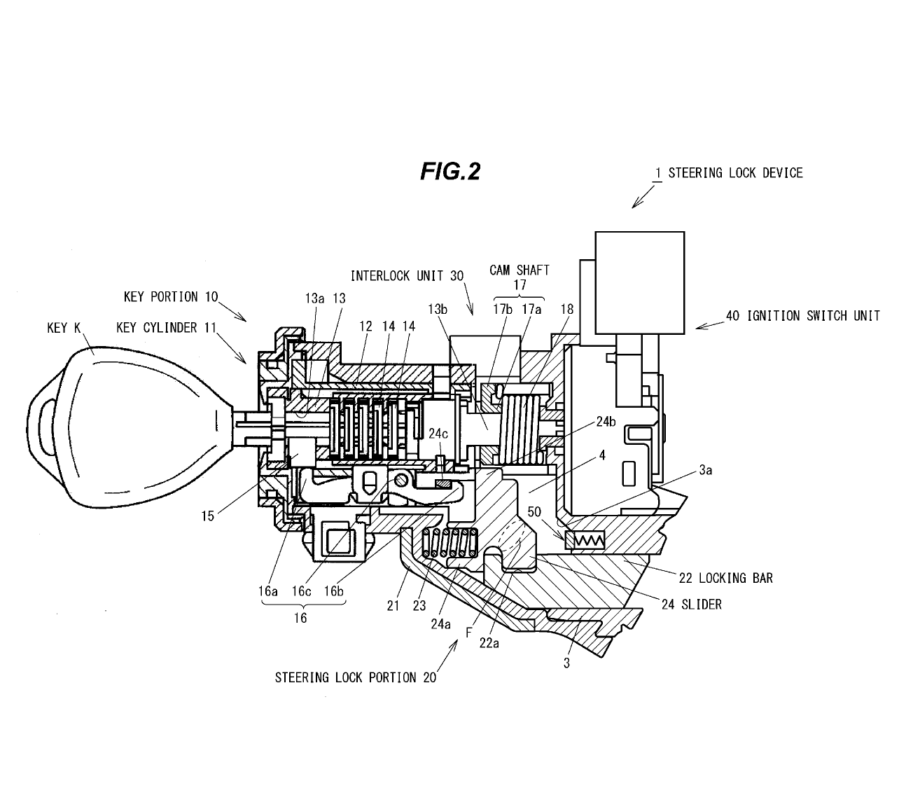

As shown in FIGS. 1A to 2, numeral 1 shows schematically the overall structure of the vehicle steering lock device. Here, in the explanation below, the insertion direction (i.e., right side in FIG. 2) of a key K is referred to “back (side)” and the removal direction (i.e., left side in FIG. 2) of the key K is referred to “front (side)”. In the front view of the key K, (the direction of) a key hole thereof is referred to vertical or horizontal.

As shown FIGS. 1A to 2, the steering lock device 1 is mainly comprised of a key portion 10, a steering lock portion 20, an interlock unit 30, and ignition switch unit 40. The steering lock device 1 has a case member 2 integrally formed of a metal material such as zinc die-cast.

As shown FIGS. 1A to 2, a protector 21 is attached to an outer wall of the case member 2 for preventing an unlawful unlocking action. The protector 21 is formed of a magnetic metal material for preventing the unlawful action using a magnet, and disposed to intersect with an extended line along which a locking bar 22 of the steering lock portion 20 moves.

Structure of the Key Portion

As shown in FIG. 2, a key cylinder 11 is enclosed in the key portion 10 on the front side of the case member 2. The key cylinder 11 is comprised of a hollow cylinder 12, and a cylindrical rotor 13 rotatably enclosed in the cylinder 12. The rotor 13 has a key hole 13a formed along the axis line direction for inserting the key K therethrough.

As shown in FIG. 2, plural tumblers 14, . . . , 14 having an elongate shape in the diameter direction (vertical direction) of the rotor 13 are enclosed movably in the rotor 13 along the longitudinal direction thereof. When the key K is not inserted into the key hole, the free end of the tumblers 14 is projected from an outer periphery of the rotor 13 to engage with an inner periphery of the cylinder 12. Thereby the rotor 13 is restrained from being rotated. On the other hand, when the key K is inserted into the rotor 112, the tumblers 14 corresponding to an end surface of a mountain-groove shape of the key K each engage with the end surface of the key K so that all of the tumblers 14 recede inside the outer periphery of the rotor 13. Thereby the rotor 13 becomes rotatable.

As shown in FIG. 2, a slide piece 15 is disposed on the front lower side of the rotor 13 movably in the diameter direction of the rotor 13. The outer surface of the slide piece 15 is curved with the same curvature as that of the outer surface of the rotor 13, so that the rotor 13 and the slide piece 15 are configured to be together rotated in the key cylinder 11. When the key K is inserted into the rotor 13, the slide piece 15 is restrained from moving toward the center of the rotor 13 since the end portion of the slide piece 15 contacts with a part of the key K.

As shown in FIG. 2, an antilock lever 16 as an elongate movable member is disposed at the lower part of the key cylinder 11 parallel to the center axis of the key cylinder 11, and supported around a support shaft 16c swingably in the vertical direction. A front end part 16a is formed at the front end (on the key hole side) of the antilock lever 16 so as to be bent toward the slide piece 15, and a back end part 16b engageable with the steering lock portion 20 is formed being bent at the back end of the antilock lever 16.

Elastic force acts on the antilock lever 16 in a direction (elevating direction) from the front end part 16a to the slide piece 15 by a spring or the like (not shown). When the rotor 13 is located at the “LOCK” position or the key K is removed from the key cylinder 11, the elastic force acts on the antilock lever 16, the front end part 16a elevates and simultaneously the back end part 16b descends so that the antilock state is canceled (i.e., the steering lock being allowed).

As shown in FIG. 2, a cam shaft 17 as a rotation member is connected with a rear shaft 13b of the rotor 13. The cam shaft 17 is provided with an inner tubular part 17a having a cylindrical shape with a small diameter and an outer tubular part 17b having a cylindrical shape with a large diameter. The inner tubular part 17a and the outer tubular part 17b are integrated at the front end part to form an inner/outer double tubular structure.

As shown in FIG. 2, a rear shaft 13b of the rotor 13 is fitted to an inner periphery of the inner tubular part 17a. A rear end part of the inner tubular part 17a projects from the case member 2 to connect with the ignition switch unit 40. When the rotor 13 is turned by the key K, the ignition switch unit 40 is operated via the cam shaft 17.

A torsion spring 18 is housed in a space between the inner tubular part 17a and the outer tubular part 17b of the cam shaft 17. One end of the torsion spring 18 engages with the outer tubular part 17b. When the rotor 13 of the key cylinder 11 reaches an “ON” position by rotation operation of the key K, the other end of the torsion spring 18 engages with the case member 2. When the key K is turned to a “START” position, spring force acts on the cam shaft 17 to return the key K from a “START” position to the “ON” position.

Structure of the Steering Lock Portion

As shown in FIG. 2, the steering lock portion 20 includes the locking bar 22, a compression spring 23 and a slider 24 as a sliding member. The steering lock portion 20 is disposed parallel to the rotor rotation axis line of the key portion 10 to downsize the steering lock device 1.

As shown in FIG. 2, the locking bar 22 is formed of a high stiffness metal material to be a locking member with an elongate plate shape, and is enclosed in a tubular lock body 3 as a case member so as to be movable back and forth in the direction parallel to the rotor rotation axis line of the rotor 13. The lock body 3 is integrally formed of a metal material such as zinc die-cast. In FIG. 2, one end of the locking bar 22 is enclosed in the lock body 3 to be retreated against the spring force of the compression spring 23 supported by a concave hole part in the case member 2, and the rotor 13 of the key cylinder 11 is at “ON” position by the turning operation of the key K.

As shown in FIG. 2, a groove part 22a is formed at a front upper part of the locking bar 22. A lower part of the slider 24 composed of a block body is fitted to the groove part 22a to be reciprocable in the rotor axis line direction. When the rotor 13 of the key cylinder 11 is at “LOCK” position, the back end surface of the slider 24 contacts with a rear inner wall 3a of the lock body 3 as an opposite wall, so that the locking bar 22 can be prevented from falling off the case member 2.

As shown in FIG. 2, a tubular spring receiving portion 24a is formed at a front lower part of the slider 24 to enclose the compression spring 23 engaged by the concave hole part in the case member 2. The locking bar 22 is operable to protrude from the back side of the lock body 3 toward a steering column 100 by the spring force of the compression spring 23.

As shown in FIG. 2, a follower part 24b is integrated at an upper part of the slider 24. The follower part 24b follows contacting with a cam surface (not shown) formed at a lower part of the outer tubular part 17b of the cam shaft 17 so as to convert the turning movement of the cam shaft 17 into the linear movement of the slider 24. An engaging protrusion 24c is formed at a front upper part of the antilock lever 16 to engage with the back end part 16b of the antilock lever 16.

The follower part 24b of the slider 24 moves on the cam surface of the cam shaft 17 when the cam shaft 17 turns together with the rotor 13 of the key cylinder 11. Thereby, the locking bar 22 can move, together with the slider 24, between a “LOCK” position for blocking the turning of a steering shaft 101 and an “UNLOCK” position for allowing the turning of the steering shaft 101.

Operation of the Steering Lock Device

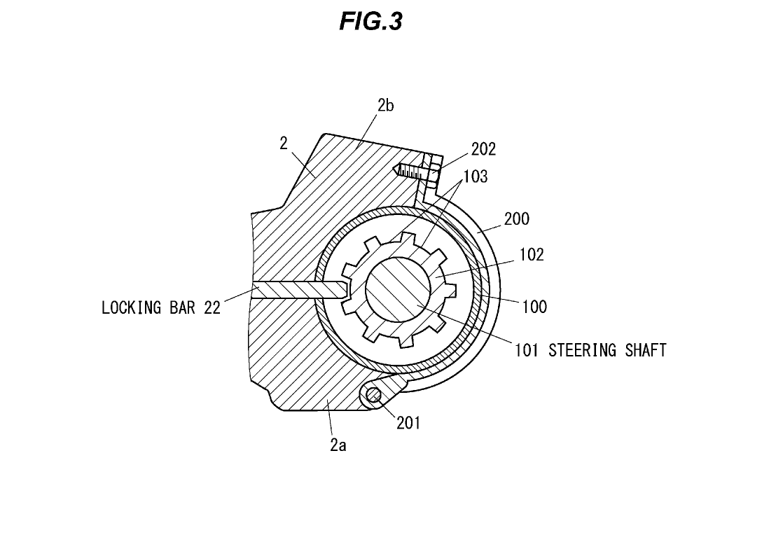

Referring to FIG. 3, the “LOCK” position is shown that the turning of the steering shaft 101 is blocked by the locking bar 22 of the vehicle steering lock device 1. One end of a bracket 200 with a semicircular arc shape is supported via a hinge shaft 201 in a hinge block part 2a of the case member 2 to allow the open/close of the bracket 200. After the bracket 200 is opened and the steering column 100 is fitted to the case member 2, the other end is fixed to a boss block part 2b of the case member 2 by a bolt 202 while the bracket 200 is closed. Thereby the steering column 100 can be mounted in the steering lock device 1.

As shown in FIG. 3, in the “LOCK” position where the locking bar 22 advances toward the steering column 100, the tip of the locking bar 22 engages with a concave portion 103 of a spline boss 102 fitted to the steering shaft 101 such that the steering shaft 101 is restrained from turning. By contrast, in the “UNLOCK” position where the locking bar 22 retreats from inside the concave portion 103 of the spline boss 102, the engagement of the locking bar 22 and the spline boss 102 is canceled to allow the turning of the steering shaft 101.

According to the configuration of the steering lock part 20, when the key K is removed from the key hole 13a, the slide piece 15 is not restrained from moving and is elevated by the front end part 16a of the antilock lever 16, and simultaneously the back end part 16b of the antilock lever 16 descends. Thus, the engaging projection 24c of the slider 24 fails to engage with the back end part 16b of the antilock lever 16 and, therefore, the locking bar 22 advances toward the “LOCK” position by the resilient expansion force of the compression spring 23.

Where the key K is inserted into the key hole 13a, in the course of turning the rotor 13 from the “LOCK” position to the “ACC” position, the outer surface of the slide piece 15 moves to the position corresponding to the outer periphery of the rotor 13, thereby the front end part 16a of the antilock lever 16 is pushed downward, and simultaneously the rear end part 16b of the antilock lever 16 is elevated. At this time, the cam shaft 17 turns in conjunction with turning of the rotor 13, thereby the engaging projection 24c moves forward together with the follower part 24b that follows contacting with the cam surface of the cam shaft 17. Simultaneously, the locking bar 22 engaging with the slider 24 via the groove part 22a retreats to the “UNLOCK” position.

When the rotor 13 reaches the “ACC” position by being turned, the engaging projection 24c of the slider 24 engages with the back end part 16b of the antilock lever 16, thereby the slider 24 is held at the position and the locking bar 22 is held at the “UNLOCK” position as well. Thereby, after the key K is turned to the “ACC” position, the steering lock device is kept into the antilock state so as to prevent the wrong operation of the steering lock.

Structure of Slider Cushioning Mechanism

Each time the rotor 13 of the key cylinder 11 is turned to the “LOCK” position, the slider 24 is subjected to a cyclic load and a shock load caused by the contact between the back end face of the slider 24 and the rear inner wall 3a of the lock body 3. A part F enclosed by broken lines in FIG. 2 is weaker part than the other parts in relation to strength. Therefore, it is necessary to prevent the crack or break of the weak part F due to metal fatigue.

A main component of the steering lock device 1 is a slider cushioning mechanism that functions to reduce a stress caused by the shape of the slider 24 and to reduce the burden of the slider 24. Thus, the overall structure of the vehicle steering lock device 1 as described above is not limited to the examples in the drawings.

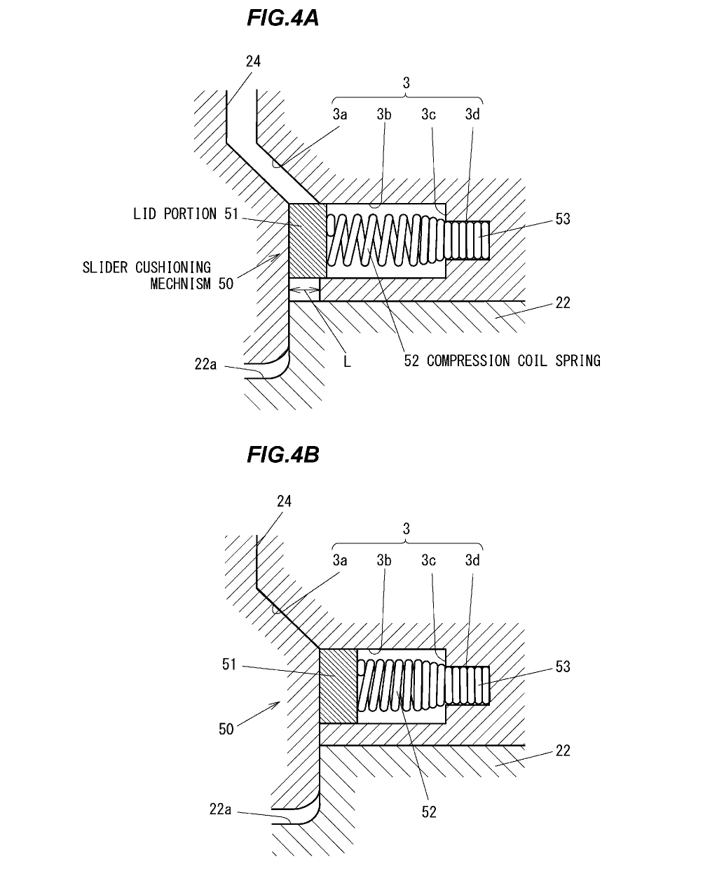

As shown in FIGS. 2, 4A and 4B, the slider cushioning mechanism 50 is comprised of a lid portion 51 to contact with the slider 24 and a compression coil spring 52 as a driving member for supporting the lid portion 51. The lid portion 51 has a shape of a block which comprises a part of the rear inner wall 3a of the lock body 3, and is disposed to protrude from the rear inner wall 3a of the lock body 3. The material and thickness of the lid portion 51 are not specially limited and the lid portion 51 may be of a metal material such as zinc die-cast. As shown in FIGS. 4A and 4B, the compression coil spring 52 is integrally formed such that a closely wound portion 53 with a small diameter is provided at one end of a pitch-wound portion with a large diameter. The material of the compression coil spring 52 is not specially limited and may be one to generate resilient force or various metal materials or resin materials. The compression coil spring 52 preferably has a spring constant less than that of the compression spring 23 for driving the locking bar 22. A proper cushioning function can be offered by setting the level of spring characteristics.

As shown in FIGS. 4A and 4B, in the rear inner wall 3a of the lock body 3, a cushion receiving portion 3b for holding the slider cushioning mechanism 50 is formed opposite the rear end face of the slider 24. The cushion receiving portion 3b has an opening communicating with a transfer space 4 of the slider 24, and is formed stepwise having a step portion 3c with a support face formed inward from an inner peripheral surface extending along the longitudinal direction. The support face of the step portion 3c supports the pitch-wound portion of the compression coil spring 52, and the closely wound portion 53 of the compression coil spring 52 is press-fitted at a press-fit groove 3d formed at the bottom of the step portion 3c.

In general, the relationship between the impulse and the change of momentum when force F is applied to an object with mass M during action time t to have a speed v is represented by a formula: Ft=Mv. Where the formula is applied to the movement of the slider 24 upon the collision, it is understood that according as the action time of the shock applied to the slider 24 shortens, the impact force F applied to the slider 24 increases. Thus, in order to decrease the impact force F received by the slider 24, it is necessary to extend the action time t. In other words, in order to extend the action time t, it is necessary to decrease the impact speed v.

Accordingly, the slider cushioning mechanism 50 of the embodiment is constructed such that in order to increase the action time upon the collision from the position where the slider 24 contacts with the lid portion 51 until reaching the rear inner wall 3a of the lock body 3, the lid portion 51 is arranged to protrude from the rear inner wall 3a of the lock body 3 via the compression coil spring 52 by a distance L sufficient to attenuate the impact speed. The appropriate cushioning effect can be obtained by suitably selecting the thickness of the lid portion 51, the spring characteristics of the compression spring 23 and the compression coil spring 52, and the interval between the slider 24 and the lid portion 51.

By using the above construction, the movement of the slider 24 can be cushioned such that the impact speed can be absorbed by the resilient force of the compression coil spring 52 before the slider 24 collides against the rear inner wall 3a of the lock body 3 due to the driving force (or resilient force) of the compression spring 23 to reduce the impact speed close to zero as much as possible when the slider 24 reaches the rear inner wall 3a of the lock body 3. Thus, the burden of the slider 24 can be reduced by cushioning the cyclic load and shock load applied to the slider 24.

Operation of the Slider Cushioning Mechanism

Referring to FIGS. 4A and 4B, the operation of the slider cushioning mechanism 50 as constructed above will be explained below. In the course of turning the rotor 13 with the key K inserted therein from the “ON” position to the “LOCK” position, as shown in FIG. 4A, the slider 24 contacts with the lid portion 51 of the slider cushioning mechanism 50 by the resilient force of the compression spring 23.

Then, as shown in FIG. 4B, the lid portion 51 is pushed back into the cushion receiving portion 3b against the resilient force of the compression coil spring 52. Here, the lid portion 51 functions to increase the action time upon the collision by the resilient force of the compression coil spring 52 and to attenuate the impact speed since it is arranged with the distance L from the position where the slider 24 contacts with the lid portion 51 until reaching the rear inner wall 3a of the lock body 3.

If the rear end face of the slider 24 directly contacts with the rear inner wall 3a of the lock body 3, the action time upon the collision decreases to increase the force applied to the slider 24. Therefore it is impossible to absorb the shock of the slider 24. Even if only the rear end face of the slider 24 or the rear inner wall 3a of the lock body 3 is provided with a resilient material, it is not preferable in terms of durability. By contrast, in the embodiment of the invention, with the distance L from the position where the slider 24 contacts with the lid portion 51 until reaching the rear inner wall 3a of the lock body 3, the impact speed upon the collision can be absorbed by the resilient force of the compression coil spring 52 to reduce the impact speed close to zero as much as possible to absorb the shock of the slider 24. Thereby, the crack or break of the weak part F due to the metal fatigue can be prevented.

Effects of the Embodiment

According to the steering lock device 1 of the embodiment as constructed above, in addition to the above effects, the stress of the slider 24 subjected to the cyclic load and shock load can be reduced and, therefore, the occurrence of the defects caused by the weak part F of the slider 24 can be prevented. Thus, the steering lock device 1 can be effectively used for a slider with a shape to increase a bending moment when receiving the cyclic load and shock load.

To secure the strength of the slider 24 against the shock load from the rear inner wall 3a of the lock body 3 allows to enhance the durability and reliability of the steering lock device 1 to secure the safety at a higher level.

Since the occurrence of the crack or break due to the metal fatigue of the weak part F of the slider 24 can be prevented, the locking bar 22 can be surely prevented from being suddenly locked despite the intention of a driver during the driving of a vehicle.

Modifications

As seen from the above description, the steering lock device 1 of the invention has been exemplified by the embodiment but the invention is not limited to the exemplified embodiment or illustrated examples in the drawings and various changes can be made without departing from the scope of the invention. For example, the following modifications can be made according to the invention.

Although in the above embodiment and illustrated examples the slider cushioning mechanism 50 is exemplified that is composed of the block-shaped lid portion 51 and the compression coil spring 52, the invention is not limited to this example. The material, dimensions, shape etc. of the slider cushioning mechanism 50 may be ones that is lightweight and can efficiently absorb the energy upon the collision. The number and position of setting the slider cushioning mechanism 50 is not specially limited if it is disposed opposite the transfer space 4 of the slider 24.

The contact surface of either one of the slider 24 and the lid portion 51 may be provided with a resilient or elastic material formed thereon. The material may be suitably designed according to the amount of the shock energy assumed. In this modification, the shock sound generated upon the contact of the slider 24 with the lid portion 51 can be reduced by using the resilient or elastic material.

Although in the above embodiment and illustrated examples the block-shaped lid portion 51 is supported by the compression coil spring 52, the invention is not limited to this example. If it is possible to have an installation space, a damper using a rubber, the air, a viscous body etc. with elasticity or resiliency may be installed instead of the spring.

Although in the above embodiment and illustrated examples the locking bar 22 and the slider 24 are driven rearward by the compression spring 23 attached to the slider 24, the invention is not limited to example. For example, the locking bar 22 and the slider 24 may be driven rearward by the compression spring 23 attached to the locking bar 22.

As seen from the above description, it should be noted that all of the combinations of features as described in the embodiments, modifications and examples mentioned above are not always needed to solve the problem of the invention.

What is claimed is:

1. A steering lock device, comprising:
a rotating member to be rotated by a key;
a locking member to move between a unlock position that a steering shaft is allowed to be rotated and a lock position that the steering shaft is prevented from being rotated;
a sliding member to move the locking member by converting the rotation of the rotating member into a linear movement;
a case member enclosing the rotating member, the locking member and the sliding member; and
a cushioning mechanism disposed in an opposite wall formed in the case member, the opposite wall being opposite to a transfer space in which the sliding member is movable,
wherein the cushioning mechanism is configured to reduce an impact force generated when the sliding member contacts with the opposite wall.

2. The steering lock device according to claim 1, wherein the cushioning mechanism comprises a lid portion to contact with the sliding member and a damping member supporting the lid portion, and
wherein the lid portion is disposed via the damping member in the opposite wall so as to protrude from the opposite wall.

3. The steering lock device according to claim 2, wherein the lid portion protrudes from the opposite wall by such a distance that a speed of the sliding member can be attenuated.

4. The steering lock device according to claim 2, wherein the damping member comprises one of a spring, a rubber, the air and a viscous body.

5. The steering lock device according to claim 2, wherein one of the sliding member and the lid portion comprises an elastic material on a contact face that the sliding member and the lid portion contact with each other.

6. The steering lock device according to claim 1, wherein the sliding member contacts with the opposite wall such that the locking member can be prevented from falling off the case member.

7. The steering lock device according to claim 1, further comprising a lock body through which the locking member is movable,
wherein the lock body comprises the opposite wall in which the cushioning mechanism is disposed.

8. The steering lock device according to claim 7, wherein the cushioning mechanism is installed in a concave portion formed in the opposite wall.

9. The steering lock device according to claim 8, wherein the cushioning mechanism comprises a lid portion to contact with the sliding member and a damping member supporting the lid portion, and
wherein the lid portion is disposed via the damping member in the concave portion so as to protrude from the opposite wall.

10. The steering lock device according to claim 9, wherein the lid portion is movable parallel to the locking member.
